(19) United States
(12) Patent Application Publication
(10) Pub. No.: US 2017/0181467 A1
(43) Pub. Date: Jun. 29, 2017

(54) METHODS AND SYSTEMS FOR A DUAL FUNCTION GAMING DEVICE

(71) Applicant: LUNATECH, LLC, Studio City, CA (US)

(72) Inventor: John D. Cameron, Studio City, CA (US)

(21) Appl. No.: 15/390,866

(22) Filed: Dec. 27, 2016

Related U.S. Application Data
(60) Provisional application No. 62/271,856, filed on Dec. 28, 2015.

(51) Int. Cl. A24F 3/00; A63F 13/92; A24F 47/00; A63F 13/25

(52) U.S. Cl. CPC A24F 3/00; A63F 13/25; A63F 13/92; A24F 47/008

(57) ABSTRACT

In an aspect, provided are systems, methods and electronic vapor devices. In an aspect, a first device can receive a second device. In an aspect, the first device can comprise a first screen. in an aspect, the second device can comprise a second screen. In an aspect, the first device can comprise a vaping component. In an aspect, the first device can comprise a gaming component. In an aspect, at least a portion of the first screen overlaps at least a portion of the second screen. In as aspect, display on the first screen and display on the second screen can be synchronized such that the first screen and the second screen appear to form a seamless third screen. In an aspect, the at least the portion of the first screen can display the same content as the at least the portion of the second screen,

### CLAIM OF PRIORITY

This application claims priority to provisional patent application Ser. No. 62/271856 filed Dec. 28, 2015, the contents of which are hereby incorporated by reference.

### BACKGROUND

Consumers can carry multiple devices. On such device includes electronic vapor cigarettes, pipes, and modified vapor devices to enjoy what is commonly known as “vaping.” Vaping is an increasingly popular market segment, which has been, and continues to, steadily gaining market share over the last several years. Various types of personal vaporizers are known in the art. In general, such vaporizers are characterized by heating a solid to a smoldering point, vaporizing a liquid by heat, or nebulizing a liquid by heat and/or by expansion through a nozzle. Such devices are designed to release aromatic materials in the solid or liquid while avoiding high temperatures of combustion and associated formation of tars, carbon monoxide, or other harmful byproducts. Consumers also carry smart phones, music players, gaming systems, and the like. The result is that consumers carry multiple devices with multiple screens. What is needed is a system and method of combining devices with screens to form a single screen to improve a portable gaming experience.

### SUMMARY

In an aspect, provided are systems, methods and electronic vapor devices. In an aspect, a first device can receive a second device. In an aspect, the first device can comprise a first screen. In an aspect, the second device can comprise a second screen. In an aspect, the first device can comprise a vaping component. In an aspect, the first device can comprise a gaming component. In an aspect, at least a portion of the first screen overlaps at least a portion of the second screen. In as aspect, display on the first screen and display on the second screen can be synchronized such that the first screen and the second screen appear to form a seamless third screen. In an aspect, the at least the portion of the first screen can display the same content as the at least the portion of the second screen.

In an aspect, a first device can be connected with a second device. In an aspect, the first device can comprise a first screen. In an aspect, the second device can comprise a second screen. In an aspect, the second device can comprise a vaping component. In an aspect, the second device can comprise a gaining component. In an aspect, at least a portion of the first screen can be overlapped by at least a portion of the second screen. In an aspect, display on the first screen and display on the second screen can be synchronized such that the first screen and the second screen appear to form a seamless third screen. In an aspect, the at least the portion of the first screen can display the same content as the at least the portion of the second screen.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The features, nature, and advantages of the present disclosure will become more apparent from the detailed description set forth below when taken in conjunction with the drawings, in which like reference characters are used to identify like elements correspondingly throughout the specification and drawings.

FIG. 1 is a block diagram of an exemplary dual function gaming device;

FIG. 2 illustrates a block diagram of another dual function gaming device;

FIG. 3 illustrates a block diagram of another exemplary dual function gaming device;

FIG. 4 illustrates a block diagram of another exemplary dual function gaming device in communication with an electronic communication device;

FIG. 5 illustrates an exemplary method for operating a hybrid gaming console and vapor device; and

FIG. 6 illustrates an exemplary method for operating a hybrid gaming console and vapor device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment, “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Various aspects are now described with reference to the drawings. in the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

The present invention pertains to creation of a system, method, and/or devices designed to integrate an electronic gaming cartridge onto a standard portable electronic device to enhance gaming and provide multiple gaming-related software options and functionality.

The present invention, in accordance with one embodiment pertains to the creation of a dual function gaming device (e.g., system, console, shuttle, cartridge, add-on device, vaping device, etc.) for an electronic communication device (e.g., smart phone, tablet, laptop, game consoles, desktops, vaping device, etc.).

The dual function gaming device can contain an updateable library of games. The dual function gaming device can comprise storage. In an aspect, the dual function gaming device can comprise a terabyte of flash data storage. In an aspect, the dual function gaming device can comprise storage in a compact drive. In an aspect, the compact drive can comprise twenty or more games in a high quality format. The dual function gaming device can comprise instructions to enable a user to have a wider array of gaming choices available to the device instantaneously. The dual function gaming device can be accessed through a port (e.g., a dedicated port for pairing with the electronic communication device, a Universal Serial Bus (USB) port, a fire-wire port, etc.)

The dual function gaming device can be used to extend the screen of the electronic communication device. The dual function gaming device can comprise a wrappable video screen enabling a seamless extension of a screen of the electronic communication device. In an aspect, the screen of the dual function gaming device can be static. In another aspect, the screen of the dual function gaming device can be movable (e.g., flexible, rollable, foldable, etc.). In a further aspect, the screen of the dual function gaming device can be rolled over the screen of the electronic communication device. In an aspect, the screen of the dual function gaming device can be tapered slightly down to match a point of cohesion with the screen of the electronic communication device. The dual function gaming device can comprise a calibration function. In an aspect, the calibration function can comprise beeping. In another aspect, the calibration function can use a visual queue to indicate when the screen of the dual function gaming device and the screen of the electronic communication device are aligned (e.g., congruent, located in an optimal cohesion position, etc.). For example, the dual function gaming device can emit a red light when the two screens are in communication but not aligned and the dual function gaming device can emit a green light when the two screens are aligned. In an aspect, when the screens are aligned, the electronic communication device can be locked into (e.g., held in place, etc.) the dual function gaming device. In an aspect, the electronic communication device can be locked by a sliding mechanism. In an aspect, the sliding mechanism can be vertical. In another aspect, the sliding mechanism can surround the electronic communication device on all four sides by virtue of a folding deployable screen. The dual function gaming device can comprise a micro-hydraulic system. The micro-hydraulic system can utilize sensors to deploy one, two, three, or four augmented edges to the screen of the electronic communication device. In another aspect, the dual function gaming device can comprise a sliding screen. In an aspect, the dual function gaming device can comprise speakers. In an aspect, the dual function gaming device can comprise extendable wings. In an aspect, the extendable wings can comprise speakers for surround sound experience with or without headphones. In an aspect, the extendable wings can comprise controls for gaming. In an aspect, an audio deployment scheme of the dual function gaming device can mirror a screen deployment scheme of the dual function gaming device by deploying equalized speaker systems in relation to a geometric configuration of the screen. In an aspect, the extendable wings can comprise display screens which may be synched to the gaming process or deploy game data such as scoring, history, and user names, and/or messages (such as messages to/from other garners, internal device messaging and/or calendar events, etc.). In an aspect, each of the extendable wings can display a different type of information. For example, a display on a left extendable wing can display a list of high scores, and a display on a right extendable wing can display a message from another gamer. A hardware deployment of the dual function gaming device can physically enable and disable a deployment of audio so the audio enabled via the physical deployment and synched with the electronic communication device.

Storage and updating of games can be done via a transmitter and instructions enabling updates to games, such as auxiliary programming of applets and patches directly to the dual function gaming device.

The dual function gaming device and the electronic communication device can synchronize with each other to deliver a seamless screen and gaming interaction. A dynamic link library (DLL) can be used to transfer video and audio from one device to the other. A connection, such as a Bluetooth connection, can be used to transfer video and audio from one device to the other. In an aspect, the devices can be in a symbiotic relationship. In an aspect, the devices can be in a parasitic relationship (e.g., one device draws resources, such as power, from the other device). In an aspect, the electronic communication device can control the audio and visual output on both devices. In an aspect, the dual function gaming device can control the audio and visual output on both devices.

In an aspect, the dual function gaining device can be a dual function electronic vapor (eVapor) device. In some aspects, the dual function eVapor device can facilitate selection, by a user, to utilize the eVapor device utilizing fluid (eJuice), containing propylene glycol (PG) and/or vegetable glycerin (VG), or select an option to use a “stealth Taping mode” and utilize eJuice that is water-based and devoid of PG and VG. In an aspect, the fluid containing PG and/or VG produces a vapor cloud, while the water-based fluid devoid of PG and VG does not create a vapor cloud during usage.

In some aspects, the PG and/or VG based eJuice can be stored in a first fluid container. The first fluid container can be a refillable container or a disposable container. The first fluid container can comprise anti-microbial and/or anti-bacterial materials within the container (e.g., on an interior surface of the first fluid container), such as silver or other anti-microbial and/or anti-bacterial compounds. A top portion of the first fluid container can comprise a wick for delivering the PG and/or VG based eJuice to a dispersing element system via a pump or other internally initiated pressure-feeding system.

The water-based eJuice can be stored in a second fluid container. In some aspects, the second fluid container can be a container completely separate from the first fluid container. In other aspects, the first fluid container and the second fluid container can be separate portions of a single larger container. The second fluid container can be a refillable container or a disposable container. The second fluid container can comprise anti-microbial and/or anti-bacterial materials within the container on an interior surface of the second fluid container), such as silver or other anti-microbial and/or anti-bacterial compounds. A top portion of the second fluid container can comprise a wick for delivering the water based eJuice to the dispersing element system via a pump or other internally initiated pressure-feeding system.

Each of the first fluid container and the second fluid container can further comprise an internal stirring or blending mechanism to help ensure that ingredients are properly dispersed. In other aspects, constituent components which comprise the eJuice can be dispersed separately and in tandem, so that the elements can be fed in proper proportions to the wick, which engages the piezoelectric dispersing element.

The dispersing element system can comprise a piezoelectric dispersing element. In some aspects, the piezoelectric dispersing element can be charged by a battery, and can be driven by a processor on a circuit board. The circuit board can be produced using a polyimide such as Kapton, or other suitable material. The piezoelectric dispersing element can comprise a thin metal disc which disperses (e.g., vaporizes, forms a mist) the fluid fed into the piezoelectric dispersing element via wick (e.g., or other soaked piece of organic material) or other disbursement mechanism such as a tiny perforated nozzle. Once in contact with the piezoelectric dispersing element, the eJuice can be vaporized (e.g., turned into vapor) and the vapor can be dispersed via a system pump and/or a sucking action of the user. In some aspects, the piezoelectric dispersing element can disperse the eJuice by producing ultrasonic vibrations. An electric field applied to a piezoelectric material within the piezoelectric element can cause ultrasonic expansion and contraction of the piezoelectric material, resulting in ultrasonic vibrations. The eJuice can be vibrated be the ultrasonic vibrations produced by the piezoelectric dispersing element, thus forming a mist vapor or unheated vapor from the liquid eJuice. In some aspects, the piezoelectric dispersing element can be used to disperse both the PG and/or VG based eJuice and the water based eJuice. In other aspects, the dispersing element system can comprise another dispersing element (e.g., a standard eCigarette dispersing element) for heating the PG and/or VG based eJuice, and the piezoelectric dispersing element can disperse the water based eJuice.

In some aspects, vapor resulting from dispersing one or both of the PG and/or VG based eJuice and the water based eJuice can be dispersed through a perforated exit to help optimize distribution of the vapor. In some aspects, the eVapor device can further comprise an inhaling mouthpiece. In some aspects, the inhaling mouthpiece can be relatively wide, having a circumference larger than that of conventional inhaling mouthpieces. For example, the mouthpiece can have a circumference of approximately 0.75 inches. This relatively wider mouthpiece can help to enable a wider opening of a user's throat so that more vapor created by the present device can reach the lungs.

In some aspects, the eVapor device can have a range of smart features controlled by the processor. The eVapor device can comprise a memory, a storage device, software; and/or a transmitter. These features can allow for monitoring and setting adjustments of the instant device, monitoring and control for authorized remote or instant 3rd parties, a full range of social networking functions, ecornmerce, integration and information exchange among other eVapor and non-eVapor communication devices and other attendant services. The device can also comprise certain verification features which allow the user to be verified as to identity and age, helping to prevent under age or otherwise unauthorized users from gaining access to the device. In some aspect, the verification features can be utilized by placing a bottom portion of the eVapor device (the cap) on a smart device (e.g., a smartphone, a handset, a tablet, and the like). The user can verify their identity and registration to the device using the smart device. The software can restrict usage of the until the verification has occurred. The verification can be enabled via a wireless, conductive electrical, or port connection between the eVapor device and the smart device, In some aspects, the smart device can comprise an accessible dossier of user information. In other aspects, the smart device can be verified via an eVapor device system application. Alternatively verification mechanisms can comprise initial verification at a retail location followed by a corresponding, ‘voice print’, signature, password, security question or fingerprint on the instant device or a networked device.

The eVapor device can utilize a stacked design. The bottom portion can comprise a cap which contains a transmitter to access and verify at least the users age and identity from a companion smart device. In some aspects, the cap can be cylindrical, having a circumference of approximately 0.75 inches. The cap can be disposed below the processor. In an aspect, the processor can be connected to a system battery disposed immediately above the processor. The processor can also be connected via wiring, coiling or other attendant conductive connections, such as interlocking metal sections which form the conductive connections to parts of the device requiring power, such as to the piezoelectric dispersing element and system pump, as well as a button which controls at least system on/off settings.

In some aspects, the dispersing element system can be fed eJuice from one or more of the first fluid container and the second fluid container as needed by a pressure pump via use of force at a bottom of the eJuice container gradually forcing the bottom of the container to move upwards and forcing the eJuice out of the container as needed. The battery can be any one of standard rechargeable or non-rechargeable batteries currently in use within eVapor devices, as well as batteries which can be charged and/or powered by a crank or kinetic energy, by solar systems, battery exchange or wind systems, or any combination thereof.

The dispersed (e.g., vaporized) eJuice can be distributed by an additional pump to the eVapor device mouthpiece. Prior to the fluid reaching the mouthpiece, the vapor can flow through a grating to disperse the vapor more effectively. In other aspects, the eJuice can flow through a spray nozzle before or after reaching the dispersing element to form a dispersed vapor. General materials to form a structure of the eVapor device can comprise metals, polymers, natural materials, porcelain, ceramic, smart materials, nano-materials and any combinations thereof. Additional heating and/or cooling systems can be added to the eVapor device to provide heat, cool, or otherwise condition the vapor before it reaches the user.

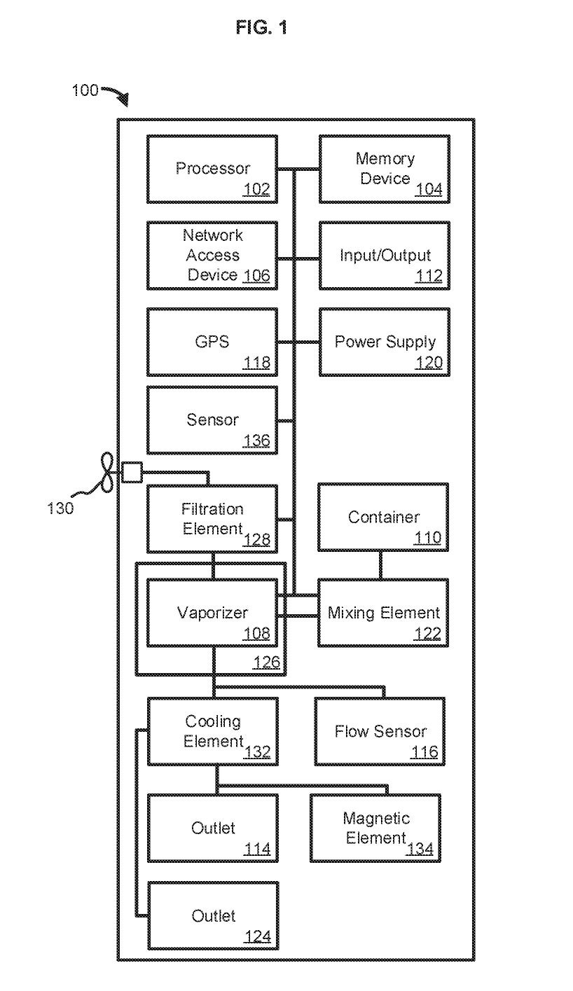

FIG. 1 is a block diagram of an exemplary dual function gaming and electronic vapor device 100 configured for vaporizing a water-based liquid as described herein. The dual function gaming and electronic vapor device 100 can be, for example, an e-cigarette, an e-cigar, an electronic vapor device, a hybrid electronic communication handset coupled/integrated vapor device, a robotic vapor device, a modified vapor device “mod,” a micro-sized electronic vapor device, a robotic vapor device, and the like. The dual function gaming and electronic vapor device 100 can comprise any suitable housing for enclosing and protecting the various components disclosed herein. The dual function gaming and electronic vapor device 100 can comprise a processor 102. The processor 102 can be, or can comprise, any suitable microprocessor or microcontroller, for example, a low-power application-specific controller (ASIC) and/or a field programmable gate array (FPGA) designed or programmed specifically for the task of controlling a device as described herein, or a general purpose central processing unit (CPU), for example, one based on 80×86 architecture as designed by IntelTM or AMD™, or a system-on-a-chip as designed by ARM™. The processor 102 can be printed or otherwise disposed on a circuit board. In some aspects, the circuit board and/or the processor can be formed using a polyimide such as Kapton, or other suitable temperature-resistant material. In other aspects, the processor 102 can comprise a standard eVapor device microprocessor. In still other embodiments, the processor 102 can comprise a hybrid microprocessor comprising elements of a Kapton-based printed microprocessor and a standard microprocessor. The processor 102 can be coupled (e.g., communicatively, operatively, etc. . . .) to auxiliary devices or modules of the dual function gaming and electronic vapor device 100 using a bus or other coupling. The dual function gaming and electronic vapor device 100 can comprise a power supply 120. The power supply 120 can comprise one or more batteries and/or other power storage device (e.g., capacitor) and/or a port for connecting to an external power supply. For example, an external power supply can supply power to the dual function gaming and electronic vapor device 100 and a battery can store at least a portion of the supplied power. The one or more batteries can be rechargeable. The one or more batteries can comprise a lithium-ion battery (including thin film lithium ion batteries), a lithium ion polymer battery, a nickel-cadmium battery, a nickel metal hydride battery, a lead-acid battery, combinations thereof, and the like. In some aspects, power can be fed from the battery via an infrastructure comprising at least one of a conductive wire, other conductive material, a conductive metal, and other material, and wherein the infrastructure is configured to connect the battery to one or more powered elements of the dual function gaming and electronic vapor device 100. In an aspect, the processor 102 can be used to run video games.

The dual function gaming and electronic vapor device 100 can comprise a memory device 104 coupled to the processor 102. The memory device 104 can comprise a random access memory (RAM) configured for storing program instructions and data for execution or processing by the processor 102 during control of the dual function gaming and electronic vapor device 100. In an aspect, the memory device 104 can comprise one or more games. In an aspect, the memory device 104 can comprise a compact flash drive. In an aspect, the memory device 104 can comprise a terabyte of memory. When the dual function gaming and electronic vapor device 100 is powered off or in an inactive state, program instructions and data can be stored in a long-term memory, for example, a non-volatile magnetic optical, or electronic memory storage device (not shown). Either or both of the RAM or the long-term memory can comprise a non-transitory computer-readable medium storing program instructions that, when executed by the processor 102, cause the dual function gaming and electronic vapor device 100 to perform all or part of one or more methods and/or operations described herein. Program instructions can be written in any suitable high-level language, for example, C, C++, C# or the Java™, and compiled to produce machine-language code for execution by the processor 102.

In an aspect, the dual function gaming and electronic vapor device 100 can comprise a network access device 106 allowing the dual function gaming and electronic vapor device 100 to be coupled to one or more ancillary devices (not shown), such as via an access point (not shown) of a wireless telephone network, local area network, or other coupling to a wide area network, for example, the Internet. In that regard, the processor 102 can be configured to share data with the one or more ancillary devices via the network access device 106. The shared data can comprise, for example, usage data and/or operational data of the dual function gaming and electronic vapor device 100, a status of the dual function gaming and electronic vapor device 100, a status and/or operating condition of one or more the components of the dual function gaming and electronic vapor device 100, text to be used in a message, a product order, payment information, and/or any other data. Similarly, the processor 102 can be configured to receive control instructions from the one or more ancillary devices via the network access device 106. For example, a configuration of the dual function gaming and electronic vapor device 100, an operation of the dual function gaming and electronic vapor device 100, and/or other settings of the dual function gaming and electronic vapor device 100, can be controlled by the one or more ancillary devices via the network access device 106. For example, an ancillary device can comprise a server that can provide various services and another ancillary device can comprise a smartphone for controlling operation of the dual function gaming and electronic vapor device 100. In some aspects, the smartphone or another ancillary device can be used as a primary input/output of the dual function gaming and electronic vapor device 100 such that data is received by the dual function gaming and electronic vapor device 100 from the server, transmitted to the smartphone, and output on a display of the smartphone.

In an aspect, the dual function gaming and electronic vapor device 100 can comprise one or more vaporizers 108. The one or more vaporizers 108 can be coupled to one or more containers 110. Each of the one or more containers 110 can be configured to hold one or more vaporizable or non-vaporizable materials. For example, the one or more containers can comprise a first container that contains a PG and/or VG based vaporizable fluid and a second container that contains a water based vaporizable fluid. The one or more vaporizer 108 can receive the one or more vaporizable or non-vaporizable materials from the one or more containers 110 and disperse (e.g., vaporize, form a mist) the one or more vaporizable or non-vaporizable materials such that the one or more vaporizable or non-vaporizable materials achieve a vapor state. In various aspects, the one or more vaporizers 108 can comprise one or more of a piezoelectric dispersing element, a heated coil element, a standard eCigarette dispersing element; a modified vapor device heating element, and the like. In some aspects, the one or more vaporizers 108 can comprise a single vaporizer comprising plural dispersing elements. For example, the one or more vaporizers 108 can comprise a single vaporizer 108 having a first dispersing element (e.g., a standard eCigarette dispersing element, a heated coil, etc.) disposed to disperse the PG and/or VG based vaporizable liquid in a first of the one or more containers 110 and a piezoelectric (second) dispersing element disposed to disperse (e.g., vaporize) the water based vaporizable liquid in a second of the one or more containers 110. In other embodiments, the one or more vaporizers 108 can comprise plural vaporizers. For example, a first vaporizer of the one or more vaporizers 108 can receive a PG and/or VG based vaporizable fluid, and a second vaporizer of the one or more vaporizers 108 can receive a water based vaporizable fluid.

In various embodiments, instead of heating the one or more vaporizable or non-vaporizable materials, the one or more vaporizers 108 can nebulize or otherwise cause the one or more vaporizable or non-vaporizable materials in the one or more containers 110 to reduce in size into particulates. In various embodiments, the one or more containers 110 can comprise a compressed liquid that can be released to the one or more vaporizers 108 via a valve or another mechanism. In various embodiments, the one or more containers 110 can comprise a wick (not shown) through which the one or more vaporizable or non-vaporizable materials is drawn to the one or more vaporizers 108. The one or more containers 110 can be made of any suitable structural material, such as, an organic polymer, metal, ceramic, composite, or glass material. in some aspects, the one or more containers 110 can comprise one or more refillable containers, one or more disposable containers, and or one or more replaceable containers. In various aspects, the one or more containers 110 can comprise internal structures that provide antibacterial or antimicrobial protections. For example, the structures can comprise at least one of silver strips and an ultraviolet (UV) light emitting device. The one or more containers 110 can further comprise a mixing system to enable even dispersal of components of the liquid.

In some aspects the water based vaporizable liquid can comprise a liquid which, when vaporized produces a drastically reduced vapor cloud when compared to traditional eJuice (e.g., a PG and/or VG based vaporizable liquid) or a liquid which, when vaporized, produces a substantially invisible vapor. For example, the water based vaporizable liquid can comprise a water-based eJuice. In an aspect, the water-based eJuice can be an eJuice having water as the primary compound therein. In some aspects, the water can be combined with one or more of a flavoring, nicotine, medication, wellness elements, aromatherapy elements (e.g., perfumes, flowers, spices, mint or aromas of a specific place and/or time, such as by way of example Fenway Park in Boston or Paris in the spring) and legal recreational elements in water soluble or controlled dispersal form. In some aspects, the water-based eJuice can be substantially free of propylene glycol (PG) and/or vegetable glycerin (VG). The water can be distilled water, purified water, spring water, tap water, water subjected to reverse osmosis, heated water, water treated with vibrational frequencies including but not limited to sound, cooled water, or water treated with at least one other element.

In an aspect, the dual function gaming and electronic vapor device 100 can also comprise an input/output device 112 coupled to one or more of the processor 102, the one or more vaporizers 108, the network access device 106, and/or any other electronic component of the dual function gaming and electronic vapor device 100. Input can be received from a user or another device and/or output can be provided to a user or another device via the input/output device 112. The input/output device 112 can comprise any combinations of input and/or output devices such as buttons, knobs, keyboards, touchscreens, displays, light-emitting elements, a speaker, and/or the like. In an aspect, the input/output device 112 can comprise an interface port (not shown) such as a wired interface, for example a serial port, a Universal Serial Bus (USB) port, an Ethernet port, or other suitable wired connection. The input/output device 112 can comprise a wireless interface (not shown), for example a transceiver using any suitable wireless protocol, for example WiFi (IEEE 802.11), Bluetooth®, infrared, or other wireless standard. For example, the input/output device 112 can communicate with a smartphone via Bluetooth® such that the inputs and outputs of the smartphone can be used by the user to interface with the dual function gaming and electronic vapor device 100. In an aspect, the input/output device 112 can allow the dual function gaming and electronic vapor device 100 to download one or more games. In an aspect, the one or more downloaded games can be stored in persistent memory within the memory device 104. In an aspect, the one or more downloaded games can be stored in cache memory within the memory device 104 during a session and removed after a period of time, such as when the session ends. In an aspect, the input/output device 112 can allow the dual function gaming and electronic vapor device 100 to communicate with other dual function gaming and electronic vapor devices 100. The dual function gaming and electronic vapor device 100 can communicate with the other dual function gaming and electronic vapor devices 100 using a peer-to-peer (P2P) model. In an aspect, the dual function gaming and electronic vapor device 100 can form a community with the other dual function gaining and electronic vapor devices 100. In an aspect, the dual function gaming and electronic vapor device 100 can form a gaming network with the other dual function gaming and electronic vapor devices 100.

Input from the input/output device 112 can be used by the processor 102 to cause the one or more vaporizers 108 to vaporize the one or more vaporizable or non-vaporizable materials. For example, a user can depress a button, causing the one or more vaporizers 108 to start vaporizing the one or more vaporizable or non-vaporizable materials. In some aspects, the input/output device 112 can also be used to receive user information (e.g., from a user smart device). The user information can be verified by the processor 102. The dual function gaming and electronic vapor device 100 and/or the smart device can comprise software for verifying the user data. The input/output device 112 can also be used to operate device system functions for one or more of usage meters, gauges, lights, sounds, skin effects, data readings, communications, ecommerce, medical care, and monitoring

In some aspects, the input/output device 112 can comprise a selection element (e.g., a button, a dial, etc.) that allows a user to select between vaporizing the PG and/or VG based vaporizable liquid and vaporizing the water based vaporizable liquid. For example, the switch can be a toggle switch that, when depressed, causes the dual function gaming and electronic vapor device 100 to activate the one or more vaporizers 108 such that a dispersing element associated with the water based vaporizable liquid is active (e.g., a “stealth mode” that produces invisible vapor clouds). In other aspects, the input/output device 112 can comprise two buttons, with each button being associated with one of the vaporizable liquids. For example, a first button of the input/output device 112 can activate the dispersing element associated with the water based vaporizable liquid, and a second button of the input/output device 112 can activate the dispersing element associated with the PG and/or VG based vaporizable liquid. In some aspects, the input/output device 112 can comprise a slider, a dial or another device that allows a user to control a mix between the PG and/or VG based vaporizable liquid and the water based vaporizable liquid. In an aspect, the input/output device 112 can comprise one or more controls for a video game. In an aspect, the input/output device 112 can comprise a movable (e.g., flexible, rollable, foldable, etc.) screen.

A user can then draw on an outlet 114 to inhale the vapor. in some aspects, vapor exiting the one or more vaporizers 108 toward the outlet 114 can flow through one or more grated exits to facilitate dispersal of the vapor. In other aspects the vapor can flow through a single opening. in still other aspects, the eJuice can be projected via a pump and a perforated nozzle before or after passing through the one or more vaporizers 108. In various aspects, the processor 102 can control vapor production and flow to the outlet 114 based on data detected by a flow sensor 116. For example, as a user draws on the outlet 114, the flow sensor 116 can detect the resultant pressure and provide a signal to the processor 102. In response, the processor 102 can cause the one or more vaporizers 108 to begin vaporizing the one or more vaporizable or non-vaporizable materials, terminate vaporizing the one or more vaporizable or non-vaporizable materials, and/or otherwise adjust a rate of vaporization of the one or more vaporizable or non-vaporizable materials. In another aspect, the vapor can exit the dual function gaming and electronic vapor device 100 through an outlet 124. The outlet 124 differs from the outlet 114 in that the outlet 124 can be configured to distribute the vapor into the local atmosphere, rather than being inhaled by a user. In an aspect, vapor exiting the outlet 124 can be at least one of aromatic, medicinal, recreational, and/or wellness related. in some aspects the outlet 114 can comprise a mouthpiece. The mouthpiece can have a circumference greater than that of a traditional &Vapor device mouthpiece. For example, the mouthpiece can have a circumference of approximately 0.75 inches. In some aspects, a seal (not shown) can be disposed between the one or more vaporizers 108 and the outlet 114.

In an aspect, the dual function gaming and electronic vapor device 100 can comprise a global positioning system (GPS) unit 118. The GPS 118 can detect a current location of the dual function gaming and electronic vapor device 100. In some aspects, a user can request access to one or more services that rely on a current location of the user. For example, the processor 102 can receive location data from the GPS 118, convert it to usable data, and transmit the usable data to the one or more services via the network access device 106. GPS unit 118 can receive position information from a constellation of satellites operated by the U.S. Department of Defense. Alternately, the GPS unit 118 can be a GLONASS receiver operated by the Russian Federation Ministry of Defense, or any other positioning device capable of providing accurate location information (for example, LORAN, inertial navigation, and the like). The UPS unit 118 can contain additional logic, either software, hardware or both to receive the Wide Area Augmentation System (WAAS) signals, operated by the Federal Aviation Administration, to correct dithering errors and provide the most accurate location possible. Overall accuracy of the positioning equipment subsystem containing WAAS is generally in the two meter range.

In an aspect, the dual function gaming and electronic vapor device 100 can comprise a mixing element 122. The mixing element 122 can be coupled to the processor 102 to receive one or more control signals. The one or more control signals can instruct the mixing element 122 to withdraw specific amounts of fluid from the one or more containers 110. The mixing element can, in response to a control signal from the processor 102, withdraw select quantities of vaporizable material in order to create a customized mixture of different types of vaporizable material. The liquid withdrawn by the mixing element 122 can be provided to the vaporizer 108.

In an aspect, the dual function gaming and electronic vapor device 100 can comprise a heating casing 126. The heating casing 126 can enclose one or more of the container 110, the vaporizer 108, and/or the outlet 114. In a further aspect, the heating casing 126 can enclose one or more components that make up the container 110, the vaporizer 108, and/or the outlet 114. The heating casing 126 can be made of ceramic, metal, and/or porcelain. The heating casing 126 can have varying thickness. In an aspect, the heating casing 126 can be coupled to the power supply 120 to receive power to heat the heating casing 126. In another aspect, the heating casing 126 can be coupled to the vaporizer 108 to heat the heating casing 126. In another aspect, the heating casing 126 can serve an insulation role.

In an aspect, the dual function gaming and electronic vapor device 100 can comprise a filtration element 128. The filtration element 128 can be configured to remove (e.g., filter, purify, etc) contaminants from air entering the dual function gaming and electronic vapor device 100. The filtration element 128 can optionally comprise a fan 130 to assist in delivering air to the filtration element 128. The dual function gaming and electronic vapor device 100 can be configured to intake air into the filtration element 128, filter the air, and pass the filtered air to the vaporizer 108 for use in vaporizing the one or more vaporizable or non-vaporizable materials. In another aspect, the dual function gaming and electronic vapor device 100 can be configured to intake air into the filtration element 128, filter the air, and bypass the vaporizer 108 by passing the filtered air directly to the outlet 114 for inhalation by a user.

In an aspect, the filtration element 128 can comprise cotton, polymer, wool, satin, meta materials and the like. The filtration element 128 can comprise a filter material that at least one airborne particle and/or undesired gas by a mechanical mechanism, an electrical mechanism, and/or a chemical mechanism. The filter material can comprise one or more pieces of a filter fabric that can filter out one or more airborne particles and/or gasses. The filter fabric can be a woven and/or non-woven material. The filter fabric can be made from natural fibers (e.g., cotton, wool, etc.) and/or from synthetic fibers (e.g., polyester, nylon, polypropylene, etc.). The thickness of the filter fabric can be varied depending on the desired filter efficiencies and/or the region of the apparel where the filter fabric is to be used. The filter fabric can be designed to filter airborne particles and/or gasses by mechanical mechanisms (e.g., weave density), by electrical mechanisms (e.g., charged fibers, charged metals, etc.), and/or by chemical mechanisms (e.g., absorptive charcoal particles, adsorptive materials, etc.). In as aspect, the filter material can comprise electrically charged fibers such as, but not limited to, FILTRETE by 3M. In another aspect, the filter material can comprise a high density material similar to material used for medical masks which are used by medical personnel in doctors' offices, hospitals, and the like. In an aspect, the filter material can be treated with an anti-bacterial solution and/or otherwise made from anti-bacterial materials. In another aspect, the filtration element 128 can comprise electrostatic plates, ultraviolet light, a HEPA filter, combinations thereof and the like.

In an aspect, the dual function gaining and electronic vapor device 100 can comprise a cooling element 132. The cooling element 132 can be configured to cool vapor exiting the vaporizer 108 prior to passing through the outlet 114. The cooling element 132 can cool vapor by utilizing air or space within the dual function gaming and electronic vapor device 100. The air used by the cooling element 132 can be either static (existing in the dual function gaming and electronic vapor device 100) or drawn into an intake and through the cooling element 132. and the dual function gaming and electronic vapor device 100. The intake can comprise various pumping, pressure, fan, or other intake systems for drawing air into the cooling element 132. In an aspect, the cooling element 132 can reside separately or can be integrated the vaporizer 108. The cooling element 132 can be a single cooled electronic element within a tube or space and/or the cooling element 132 can be configured as a series of coils or as a grid like structure. The materials for the cooling element 132 can be metal, liquid, polymer, natural substance, synthetic substance, air, or any combination thereof. The cooling element 132 can be powered by the power supply 120, by a separate battery (not shown), or other power source (not shown) including the use of excess heat energy created by the vaporizer 108 being converted to energy used for cooling by virtue of a small turbine or pressure system to convert the energy. Heat differentials between the vaporizer 108 and the cooling element 132 can also be converted to energy utilizing commonly known geothermal energy principles.

In an aspect, the dual function gaining and electronic vapor device 100 can comprise a magnetic element 134. For example, the magnetic element 134 can comprise an electromagnet, a ceramic magnet, a ferrite magnet, and/or the like. The magnetic element 134 can be configured to apply a magnetic field to air as it is brought into the dual function gaming and electronic vapor device 100, in the vaporizer 108, and/or as vapor exits the outlet 114.

The input/output device 112 can be used to select whether vapor exiting the outlet 114 should be cooled or not cooled and/or heated or not heated and/or magnetized or not magnetized. For example, a user can use the input/output device 112 to selectively cool vapor at times and not cool vapor at other times. The user can use the input/output device 112 to selectively heat vapor at times and not heat vapor at other times. The user can use the input/output device 112 to selectively magnetize vapor at times and not magnetize vapor at other times. The user can further use the input/output device 112 to select a desired smoothness, temperature, and/or range of temperatures. The user can adjust the temperature of the vapor by selecting or clicking on a clickable setting on a part of the dual function gaming and electronic vapor device 100. The user can use, for example, a graphical user interface (GUI) or a mechanical input enabled by virtue of clicking a rotational mechanism at either end of the dual function gaming and electronic vapor device 100.

In an aspect, cooling control can be set within the dual function gaming and electronic vapor device 100 settings via the processor 102 and system software (e.g., dynamic linked libraries). The memory 104 can store settings. Suggestions and remote settings can be communicated to and/or from the dual function gaming and electronic vapor device 100 via the input/output device 112 and/or the network access device 106. Cooling of the vapor can be set and calibrated between heating and cooling mechanisms to what is deemed an ideal temperature by the manufacturer of the dual function gaming and electronic vapor device 100 for the vaporizable material. For example, a temperature can be set such that resultant vapor delivers the coolest feeling to the average user but does not present any health risk to the user by virtue of the vapor being too cold, including the potential for rapid expansion of cooled vapor within the lungs and the damaging of tissue by vapor which has been cooled to a temperature which may cause frostbite like symptoms.

In an aspect, the dual function gaming and electronic vapor device 100 can be configured to receive air, smoke, vapor or other material and analyze the contents of the air, smoke, vapor or other material using one or more sensors 136 in order to at least one of analyze, classify, compare, validate, refute, and/or catalogue the same. A result of the analysis can be, for example, an identification of at least one of medical, recreational, homeopathic, olfactory elements, spices, other cooking ingredients, ingredients analysis from food products, fuel analysis, pharmaceutical analysis, genetic modification testing analysis, dating, fossil and/or relic analysis and the like. The dual function gaming and electronic vapor device 100 can pass utilize, for example, mass spectrometry, PH testing, genetic testing, particle and/or cellular testing, sensor based testing and other diagnostic and wellness testing either via locally available components or by transmitting data to a remote system for analysis.

In an aspect, a user can create a custom scent by using the dual function gaming and electronic vapor device 100 to intake air elements, where the dual function gaming and electronic vapor device 100 (or third-party networked device) analyzes the olfactory elements and/or biological elements within the sample and then formulates a replica scent within the dual function gaming and electronic vapor device 100 (or third-party networked device) that can be accessed by the user instantly, at a later date, with the ability to purchase this custom scent from a networked ecommerce portal.

In another aspect, the one or more sensors 136 can be configured to sense negative environmental conditions (e.g., adverse weather, smoke, fire, chemicals (e.g., such as CO2 or formaldehyde), adverse pollution, and/or disease outbreaks, and the like). The one or more sensors 136 can comprise one or more of, a biochemical/chemical sensor, a thermal sensor, a radiation sensor, a mechanical sensor, an optical sensor, a mechanical sensor, a magnetic sensor, an electrical sensor, combinations thereof and the like. The biochemical/chemical sensor can be configured to detect one or more biochemical/chemicals causing a negative environmental condition such as, but not limited to, smoke, a vapor, a gas, a liquid, a solid, an odor, combinations thereof, and/or the like. The biochemical/chemical sensor can comprise one or more of a mass spectrometer, a conducting/nonconducting regions sensor, a SAW sensor, a quartz microbalance sensor, a conductive composite sensor, a chemiresitor, a metal oxide gas sensor, an organic gas sensor, a MOSFET, a piezoelectric device, an infrared sensor, a sintered metal oxide sensor, a Pd-gate MOSFET, a metal FET structure, a electrochemical cell, a conducting polymer sensor, a catalytic gas sensor, an organic semiconducting gas sensor, a solid electrolyte gas sensors, a piezoelectric quartz crystal sensor, and/or combinations thereof.

The thermal sensor can be configured to detect temperature, heat, heat flow, entropy, heat capacity, combinations thereof, and the like. Exemplary thermal sensors include, but are not limited to, thermocouples, such as a semiconducting thermocouples, noise thermometry, thermoswitches, thermistors, metal thermoresistors, semiconducting thermoresistors, thermodiodes, thermotransistors, calorimeters, thermometers, indicators, and fiber optics.

The radiation sensor can be configured to detect gamma rays, X-rays, ultra-violet rays, visible, infrared, microwaves and radio waves. Exemplary radiation sensors are suitable for use in the present invention that include, but are not limited to, nuclear radiation microsensors, such as scintillation counters and solid state detectors, ultra-violet, visible and near infrared radiation microsensors, such as photoconductive cells, photodiodes, phototransistors, infrared radiation microsensors, such as photoconductive IR sensors and pyroelectric sensors.

The optical sensor can be configured to detect visible, near infrared, and infrared waves. The mechanical sensor can be configured to detect displacement, velocity, acceleration, force, torque, pressure, mass, flow, acoustic wavelength, and amplitude. Exemplary mechanical sensors are suitable for use in the present invention and include, but are not limited to, displacement microsensors, capacitive and inductive displacement sensors, optical displacement sensors, ultrasonic displacement sensors, pyroelectric, velocity and flow microsensors, transistor flow microsensors, acceleration microsensors, piezoresistive microaccelerometers, force, pressure and strain microsensors, and piezoelectric crystal sensors. The magnetic sensor can be configured to detect magnetic field, flux, magnetic moment, magnetization, and magnetic permeability. The electrical sensor can be configured to detect charge, current, voltage, resistance, conductance, capacitance, inductance, dielectric permittivity, polarization and frequency.

Upon sensing a negative environmental condition, the one or more sensors 136 can provide data to the processor 102 to determine the nature of the negative environmental condition and to generate/transmit one or more alerts based on the negative environmental condition. The one or more alerts can be deployed to the dual function gaming and electronic vapor device 100 user's wireless device and/or synced accounts. For example, the network device access device 106 can be used to transmit the one or more alerts directly (e.g., via Bluetooth®) to a user's smartphone to provide information to the user. In another aspect, the network access device 106 can be used to transmit sensed information and/or the one or more alerts to a remote server for use in syncing one or more other devices used by the user (e.g., other vapor devices, other electronic devices (smartphones, tablets, laptops, etc.). In another aspect, the one or more alerts can be provided to the user of the dual function gaming and electronic vapor device 100 via vibrations, audio, colors, and the like deployed from the mask, for example through the input/output device 112. For example, the input/output device 112 can comprise a small vibrating motor to alert the user to one or more sensed conditions via tactile sensation. In another example, the input/output device 112 can comprise one or more LED's of various colors to provide visual information to the user. In another example, the input/output device 112 can comprise one or more speakers that can provide audio information to the user. For example, various patterns of beeps, sounds, and/or voice recordings can be utilized to provide the audio information to the user. In another example, the input/output device 112 can comprise an LCD screen/touchscreen that provides a summary and/or detailed information regarding the negative environmental condition and/or the one or more alerts.

In another aspect, upon sensing a negative environmental condition, the one or more sensors 136 can provide data to the processor 102 to determine the nature of the negative environmental condition and to provide a recommendation for mitigating and/or to actively mitigate the negative environmental condition. Mitigating the negative environmental conditions can comprise, for example, applying a filtration system, a fan, a fire suppression system, engaging a HVAC system, and/or one or more vaporizable and/or non-vaporizable materials. The processor 102 can access a database stored in the memory device 104 to make such a determination or the network device 106 can be used to request information from a server to verify the sensor findings. In an aspect, the server can provide an analysis service to the dual function gaming and electronic vapor device 100. For example, the server can analyze data sent by the dual function gaming and electronic vapor device 100 based on a reading from the one or more sensors 136. The server can determine and transmit one or more recommendations to the dual function gaming and electronic vapor device 100 to mitigate the sensed negative environmental condition. The dual function gaming and electronic vapor device 100 can use the one or more recommendations to activate a filtration system, a fan, a fire suppression system engaging a HVAC system, and/or to vaporize one or more vaporizable or non-vaporizable materials to assist in countering effects from the negative environmental condition.

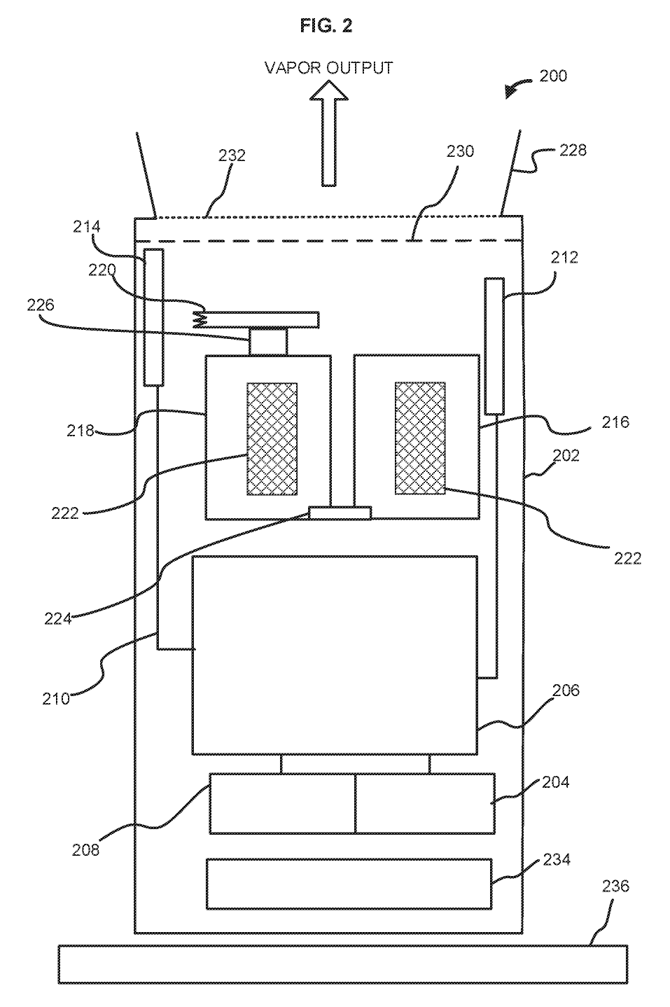

FIG. 2 shows an exemplary dual function gaming and electronic vapor device 200 as described herein. The dual function gaming and electronic vapor device 200 can be, for example, an e-cigarette, an c-cigar, an electronic vapor device, a hybrid electronic communication handset coupled/integrated vapor device, a robotic vapor device, a modified vapor device “mod,” a micro-sized electronic vapor device, a robotic vapor device, and the like. The dual function gaming and electronic vapor device 200 can comprise any suitable housing 202 for enclosing and protecting the various components disclosed herein. The dual function gaming and electronic vapor device 200 can comprise a processor 204. The processor 204 can be, or can comprise, any suitable microprocessor or microcontroller, for example, a low-power application-specific controller (ASIC) and/or a field programmable gate array (FPGA) designed or programmed specifically for the task of controlling a device as described herein, or a general purpose central processing unit (CPU), for example, one based on 80×86 architecture as designed by Intel™ or AMD™, or a system-on-a-chip as designed by ARM™. The processor 204 can be printed or otherwise disposed on a circuit board. In some aspects, the circuit board and/or the processor can be formed using a polyimide such as Kapton, or other suitable temperature-resistant material. In other aspects, the processor 204 can comprise a standard eVapor device microprocessor. In still other embodiments, the processor 204 can comprise a hybrid microprocessor comprising elements of a Kapton-based printed microprocessor and a standard microprocessor. The processor 204 can be coupled (e.g., communicatively, operatively, etc. . . . ) to auxiliary devices or modules of the dual function gaming and electronic vapor device 200 using a bus or other coupling. The dual function gaming and electronic vapor device 200 can comprise a power supply 206. The power supply 206 can comprise one or more batteries and/or other power storage device (e.g., capacitor) and/or a port for connecting to an external power supply. For example, an external power supply can supply power to the dual function gaming and electronic vapor device 200 and a battery can store at least a portion of the supplied power. The one or more batteries can be rechargeable. The one or more batteries can comprise a lithium-ion battery (including thin film lithium ion batteries), a lithium ion polymer battery, a nickel-cadmium battery, a nickel metal hydride battery, a lead-acid battery, combinations thereof, and the like. In some aspects, power can be fed from the battery via an infrastructure comprising at least one of a conductive wire, other conductive material, a conductive metal, and other material, and wherein the infrastructure is configured to connect the battery to one or more powered elements of the dual function gaming and electronic vapor device 200. In an aspect, the processor 204 can be used to run video games.

The dual function gaming and electronic vapor device 200 can comprise a memory device 208 coupled to the processor 204. The memory device 208 can comprise a random access memory (RAM) configured for storing program instructions and data for execution or processing by the processor 204 during control of the dual function gaming and electronic vapor device 200. In an aspect, the memory device 208 can comprise one or more games. In an aspect, the memory device 208 can comprise a compact flash drive. In an aspect, the memory device 208 can comprise a terabyte of memory. The memory device 208 can further comprise a long-term memory, for example, a non-volatile magnetic optical, or electronic memory storage device, for storing program instructions and data when the dual function gaming and electronic vapor device 200 is powered off or in an inactive state. Either or both of the RAM or the long-term memory can comprise a non-transitory computer-readable medium storing program instructions that, when executed by the processor 204, cause the dual function gaming and electronic vapor device 200 to perform all or part of one or more methods and/or operations described herein. Program instructions can be written in any suitable high-level language, for example, C, C++, C# or Java™, and compiled to produce machine-language code for execution by the processor 204. The processor 204 can also be used to operate device system functions for one or more of usage meters, gauges, lights, sounds, skin effects, data readings, communications, ecommerce, medical care, and monitoring

In an aspect, the dual function gaming and electronic vapor device 200 can comprise a first dispersing element 212 and a second dispersing element 214. In various aspects, the first dispersing element 212 can comprise one or more of a heated coil element, a standard eCigarette dispersing element, a modified vapor device heating element, and the like. The first dispersing element 212 can be coupled to one or more first containers 216. For example, the one or more first containers 216 can comprise a batting material soaked in PG and/or VG based vaporizable liquid. The second dispersing element 214 can be coupled to one or more second containers 218 via a wick 220. Each of the one or more second containers 218 can be configured to hold water based vaporizable liquid. The second dispersing element 214 can receive the water-based vaporizable liquid from the one or more second containers 218 and disperse (e.g., vaporize, form a mist from) the water-based vaporizable liquid until the water-based vaporizable liquid achieve a vapor state.

In some aspects, the connection between the power supply 206 and one or more of the powered elements (e.g., the second dispersing element 214) can be facilitated using one or more conductive coils 210. The conductive coils 210 can provide an ultrasonic power input to the second dispersing element 214. For example, the signal carried by the coil can have a frequency of approximately 107.8 kHz, In some aspects, the second dispersing element 214 can comprise a piezoelectric dispersing element that can receive the ultrasonic signal transmitted from the power supply 206 through the coils 210, and can disperse (e.g., vaporize, form a mist from) the vaporizable liquid by producing ultrasonic vibrations. An ultrasonic electric field applied to a piezoelectric material within the piezoelectric element causes ultrasonic expansion and contraction of the piezoelectric material, resulting in ultrasonic vibrations according to the frequency of the signal. The vaporizable liquid can be vibrated by the piezoelectric dispersing element, thus causing vaporization of the vaporizable liquid.

Each of the one or more first containers 216 and the one or more second containers 218 can be made of any suitable structural material, such as, an organic polymer, metal, ceramic, composite, or glass material. in some aspects, the one or more first containers 216 and the one or more second containers 218 can comprise one or more refillable containers, one or more disposable containers, and/or one or more replaceable containers. In various aspects, the one or more first containers 216 and/or the one or more second containers 218 can comprise internal structures 222 that provide antibacterial or antimicrobial protections. For example, the structures 222 can comprise at least one of silver strips and an ultraviolet (UV) light emitting device. The one or more first containers 216 and the one or more second containers 218 can further comprise a mixing system 224 to enable even dispersal of components of the liquids. in some aspects, the mixing system 222 can facilitate mixing of the PG and/or VG based vaporizable liquid from the first container 216 and the water based vaporizable liquid from the second container 218. In various embodiments, a pump 226 can facilitate transmission of the water-based vaporizable liquid from the second container 218 to the wick 220.

In some aspects the water-based liquid can comprise a liquid which, when vaporized produces a drastically reduced vapor cloud when compared to traditional eJuice or a liquid which, when vaporized, produces a substantially invisible vapor. In an aspect, the water-based liquid can be an eJuice having water as the primary compound therein. In some aspects, the water can be combined with one or more of a flavoring, nicotine, medication, wellness elements, aromatherapy elements (e.g., perfumes, flowers, spices, mint or aromas of a specific place and/or time, such as by way of example Fenway Park in Boston or Paris in the spring) and legal recreational elements in water soluble or controlled dispersal form. In some aspects, the water-based liquid can be substantially free of propylene glycol (PG) and/or vegetable glycerin (VG). The water can be distilled water, purified water, spring water, tap water, water subjected to reverse osmosis, heated water, water treated with vibrational frequencies including but not limited to sound, cooled water, or water treated with at least one other element.

A user can then draw on an outlet 228 to inhale the vapor. In some aspects, vapor exiting the first dispersing element 212 and/or the second dispersing element 214 toward the outlet 228 can flow through one or more grated exits 230 to facilitate dispersal of the vapor. In various aspects, the processor 204 can control vapor production and flow from each of the first dispersing element 212 and/or the second dispersing element 214 to the outlet 228. In some aspects, the outlet 228 can comprise a mouthpiece. The mouthpiece can have a circumference greater than that of a traditional eVapor device mouthpiece. For example, the mouthpiece can have a circumference of approximately 0.75 inches. In some aspects, a seal 232 can be disposed between the first and second dispersing elements 212, 214 and the outlet 228. The seal 232 can be vapor-impermeable when the dual function gaming and electronic vapor device 200 is not in active use, and suction applied to the mouthpiece by the user can cause the seal 232 to break temporarily, allowing flow of vapor through the outlet 228 for inhalation by the user.

In an aspect, the dual function gaming and electronic vapor device 200 can also comprise a transmitter 234 coupled to one or more of the processor 204, the first dispersing element 212, the second dispersing element 214, and/or any other electronic component of the dual function gaming and electronic vapor device 200. input can be received from an electronic communication device 236 associated with the user. In some aspects, the transmitter 234 can comprise an interface port such as a wired interface, for example a serial port, a Universal Serial Bus (USB) port, an Ethernet port, or other suitable wired connection. In some aspects, the transmitter 234 can comprise a wireless interface, for example a transceiver using any suitable wireless protocol, for example WiFi (IEEE 802.11), Bluetooth®, infrared, or other wireless standard. For example, the transmitter 234 can communicate with a smartphone via Bluetooth® such that the inputs and outputs of the smartphone can be used by the user to interface with the dual function gaming and electronic vapor device 200. In an aspect, the transmitter 234 can allow the dual function gaming and electronic vapor device 200 to download one or more games. In an aspect, the one or more downloaded games can be stored in persistent memory within the memory device 208. In an aspect, the one or more downloaded games can be stored in cache memory within the memory device 208 during a session and removed after a period of time, such as when the session ends, In an aspect, the transmitter 234 can allow the dual function gaming and electronic vapor device 200 to communicate with other dual function gaming and electronic vapor devices 200. The dual function gaming and electronic vapor device 200 can communicate with the other dual function gaming and electronic vapor devices 200 using a peer-to-peer (P2P) model. In an aspect, the dual function gaming and electronic vapor device 200 can form a community with the other dual function gaming and electronic vapor devices 200. In an aspect, the dual function gaming and electronic vapor device 200 can form a gaming network with the other dual function gaming and electronic vapor devices 200.

Input from the transmitter 234 can be used by the processor 204 to cause the first dispersing element 212 to vaporize the PG and/or VG based vaporizable liquid and/or to cause the second dispersing element 214 to vaporize the water based vaporizable liquid. For example, a user can depress a first button, causing the first dispersing element 212 to start vaporizing the PG and/or VG based vaporizable liquid. The user can depress a second button, causing the second dispersing element to start vaporizing the water based vaporizable liquid. In some aspects, the transmitter 234 can be used to receive user information (e.g., from the user electronic communication device 236). The user information can be verified by the processor 204. The dual function gaming and electronic vapor device 200 and/or the electronic communication device 236 can comprise software for verifying the user data.

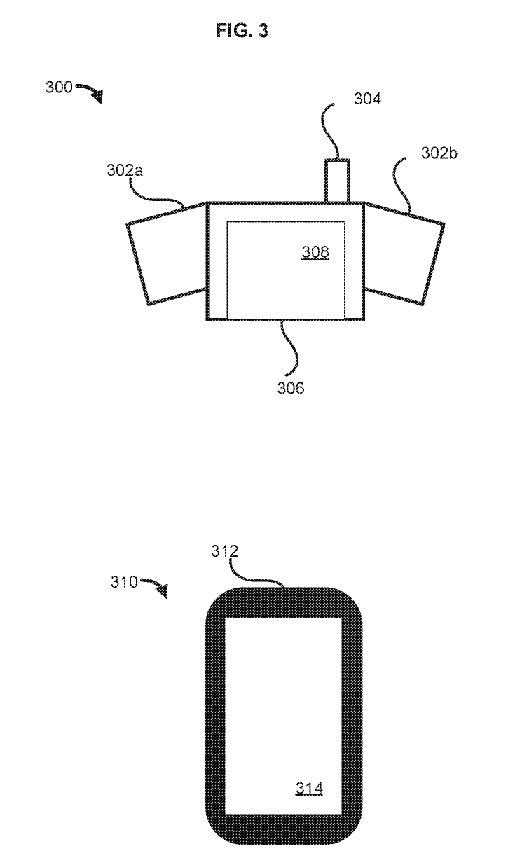

In an aspect, illustrated in FIG. 3 is a dual function gaming and electronic vapor device 300 and an electronic communication device 310. In an aspect, the dual function gaming and electronic vapor device 300 can comprise one or more extendable wings 302a, 302h. In an aspect, the one or more extendable wings 302a, 302b can comprise speakers for surround sound. experience with or without headphones, In an aspect, the one or more extendable wings 302a, 302b can comprise controls for gaming. In an aspect, the one or more extendable wings 302a, 302b can comprise display screens which may be synched to the gaming process or deploy game data such as scoring, history, and user names, and/or messages (such as messages to/from other garners, internal device messaging and/or calendar events, etc.). In an aspect, each of the one or more extendable wings 302a, 302b can display a different type of information. For example, a display on a left extendable wing 302a can display a list of high scores, and a display on a right extendable wing 302b can display a message from another garner.

In an aspect, the dual function gaming and electronic vapor device 300 can comprise a vaping component 304. The vaping component 304 can be similar to 100 and/or 200 described in FIGS. 1 and 2 respectively. In an aspect, the dual function gaming and electronic vapor device 300 can comprise a portion 306 for receiving the electronic communication device 310. In an aspect, the portion 306 can comprise a cavity for placement of the electronic communication device 310. In an aspect, the portion 306 can comprise a port for connecting the dual function gaining and electronic vapor device 300 with the electronic communication device 310. in an aspect, the port for connection can comprise a proprietary, dedicated port for pairing with the electronic communication device 310. In an aspect, the port for connection can comprise a Universal Serial Bus (USB) port. In an aspect, the port for connection can comprise a firewire port. In an aspect, the portion 306 can comprise a connector for connection with a port. In an aspect, the connector can be a connection for a proprietary, dedicated port for pairing with the electronic communication device 310. In an aspect, the connector for connection can be for a Universal Serial Bus (USB) port. In an aspect, the connector for connection can be for a firewire port. In an aspect, the dual function gaming and electronic communication device 300 can comprise a screen 308. In an aspect, the screen 308 can be movable (e.g., flexible, rollable, foldable, etc.). In an aspect, the screen 308 can be configured to slide.

In an aspect, the electronic communication device 310 can be a mobile (e.g., smart phone, tablet, etc.). In an aspect, the electronic communication device 310 can comprise a portion 312 for communication with the dual function gaming and electronic vapor device 300. In an aspect, the portion 312 can comprise a physical portion for residing in a cavity. In an aspect, the portion 312 can comprise a connector for connection with a port. In an aspect, the connector can be a connection for a proprietary, dedicated port for pairing with the dual function gaming and electronic vapor device 300. In an aspect, the connector for connection can be for a Universal Serial Bus (USB) port. In an aspect, the connector for connection can be for a firewire port. In an aspect, the portion 312 can comprise a port for connecting the electronic communication device 310 with the dual function gaining and electronic vapor device 300. In an aspect, the port for connection can comprise a proprietary, dedicated port for pairing with the dual function gaming and electronic vapor device 300. In an aspect, the port for connection can comprise a Universal Serial Bus (USB) port. In an aspect, the port for connection can comprise a firewire port. The electronic communication device 310 can comprise a screen 314.

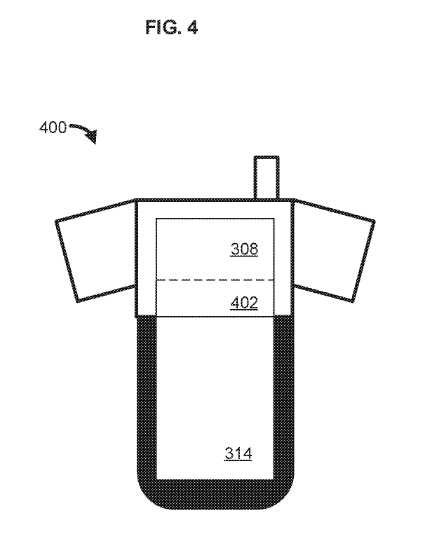

In an aspect, illustrated in FIG. 4 is the dual function gaming and electronic vapor device in communication with the electronic communication device 400. In an aspect, a first screen 308, for example, the screen of the dual function gaming and electronic vapor device can connect with a second screen 314, for example, the screen of the electronic communication device to form a single seamless third screen. In an aspect, a portion of the first screen 308 and a portion of the second screen 314 can overlap 402. In an aspect, the overlapping portions 402 can display the same content. In an aspect, the overlapping portions 402 can display the same pixels. In an aspect, the first screen 308 can be wrapped tightly with the second screen 314, such that the first screen and the second screen 314 appear to for the third single screen.

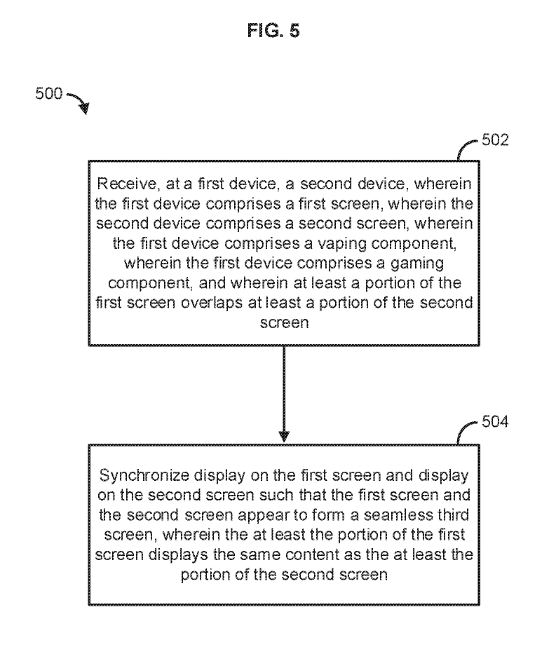

Illustrated in FIG. 5 is an exemplary method 500. In step 502, a first device can receive a second device. The first device can comprise a first screen. The second device can comprise a second screen. The first device can comprise a vaping component. The first device can comprise a gaming component. At least a portion of the first screen can overlap at least a portion of the second screen. In an aspect, the first device can comprise an updateable library of games. In an aspect, the first device can comprise at least one terabyte of flash data storage. In an aspect, the first device can comprise at least twenty games. In an aspect, the first screen can be wrappable. In an aspect, the first screen can be flexible. In an aspect, the second device can be a smart phone.

In step 504, display on the first screen and display on the second screen can be synchronized such that the first screen and the second screen appear to form a seamless third screen. The at least the portion of the first screen can display the same content as the at least the portion of the second screen. A plurality of pixels associated with the at least the portion of the first screen can be the same as a corresponding plurality of pixels associated with the at least the portion of the second screen. In an aspect, the first device can control what is displayed on the first screen and the second screen. In an aspect, the second device can control what is displayed on the first screen and the second screen. In an aspect, the first device can comprise a first audio output. In an aspect, the second device can comprise a second audio output. In an aspect, the first device can control what is heard via the first audio output and the second audio output. In an aspect, the second device can control what is heard via the first audio output and the second audio output.

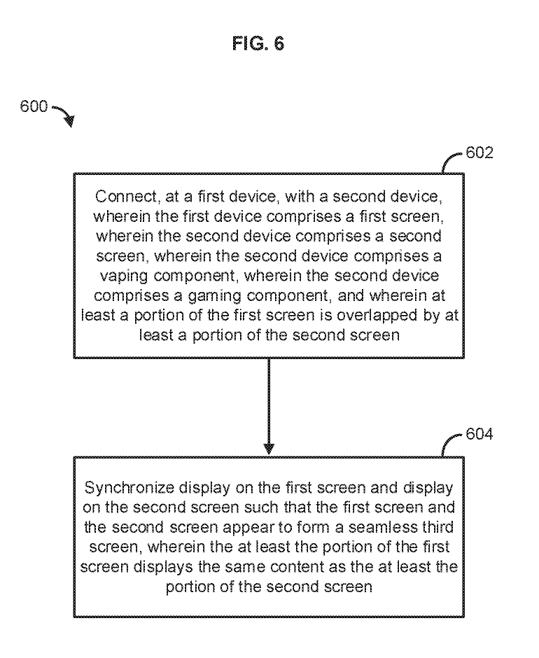

Illustrated in FIG. 6 is an exemplary method 600. In step 602, a first device can connect with a second device. The first device can comprise a first screen. The second device can comprise a second screen. The second device can comprise a vaping component. The second device can comprise a gaming component. At least a portion of the first screen can be overlapped by at least a portion of the second screen. In an aspect, the second device can comprise an updateable library of games. In an aspect, the second device can comprise at least one terabyte of flash data storage. In an aspect, the second device can comprise at least twenty games. In an aspect, the second screen can be wrappable. In an aspect, the second screen can be flexible. In an aspect, the first device can be a smart phone.

In step 604, display on the first screen and display on the second screen can be synchronized such that the first screen and the second screen appear to form a seamless third screen. The at least the portion of the first screen can display the same content as the at least the portion of the second screen. A plurality of pixels associated with the at least the portion of the first screen can be the same as a corresponding plurality of pixels associated with the at least the portion of the second screen. In an aspect, the first device can control what is displayed on the first screen and the second screen. In an aspect, the second device can control what is displayed on the first screen and the second screen. In an aspect, the first device can comprise a first audio output. In an aspect, the second device can comprise a second audio output. In an aspect, the first device can control what is heard via the first audio output and the second audio output. In an aspect, the second device can control what is heard via the first audio output and the second audio output.

In view of the exemplary systems and methods described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used herein, a “vapor” includes mixtures of a carrier gas or gaseous mixture (for example, air) with any one or more of a dissolved gas, suspended solid particles, or suspended liquid droplets, wherein a substantial fraction of the particles or droplets if present are characterized by an average diameter of not greater than three microns. As used herein, “vapor” can include both non-heated vapor (e.g., a mist vapor) and heated vapor. As used herein, “vaporization” can include forming a non-heated vapor (e.g., a mist vapor) as well as forming a heated vapor. As used herein, an “aerosol” has the same meaning as “vapor,” except for requiring the presence of at least one of particles or droplets. A substantial fraction means 10% or greater; however, it should be appreciated that higher fractions of small (<3 micron) particles or droplets may be desirable, up to and including 100%. It should further be appreciated that, to simulate smoke, average particle or droplet size may be less than three microns, for example, may be less than one micron with particles or droplets distributed in the range of 0.01 to 1 micron. A vaporizer may include any device or assembly that produces a vapor or aerosol from a carrier gas or gaseous mixture and at least one vaporizable material. An aerosolizer is a species of vaporizer, and as such is included in the meaning of vaporizer as used herein, except where specifically disclaimed.

Various aspects presented in terms of systems can comprise a number of components, modules, and the like. It is to be understood and appreciated that the various systems may include additional components, modules, etc. and/or may not include all of the components, modules, etc. discussed in connection with the figures. A combination of these approaches can also be used.

In addition, the various illustrative logical blocks, modules, and circuits described in connection with certain aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, RUM memory, EPROM memory, EEPROM memory, registers, hard disk, a removable disk, a CD-ROM, a DVD disk, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Those skilled in the art will recognize many modifications may be made to this configuration without departing from the scope of the disclosed aspects.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. An electronic vapor and gaming multimedia hybrid shuttle device having a vapor operation and a gaming operation, wherein the hybrid shuttle device is operable physically and functionally in tandem with a second electronic communication device, wherein the hybrid shuttle device comprises a first screen, and wherein the second electronic communication device comprises a second screen.

2. The device of claim 1, wherein the hybrid shuttle device contains twenty or more full games in high quality digital format.

3. The device of claim 1, wherein the hybrid shuttle device communicates with the second electronic communication device to synchronize a display across the first and second screens.

4. The device of claim 1, wherein the hybrid shuttle comprises at least one of extendable winged elements to display additional information and extendable audio speakers.

5. The device of claim 1, further including a fit-to-lock mechanism using at least one of hydraulics, screw to tighten mechanism, push button, and switch deploy motorized fitting, wherein the first and second screens cooperate to provide a seam-to-seam affixed display-to-display continuous screen look by locking a sensor guided beveled edge of the first screen to the second electronic communication device at an edge of the second screen.

6. The device of claim 1, wherein the hybrid shuttle device utilizes a water-based eLiquid and a PG and/or VG based eLiquid.

7. The device of claim 6, wherein one or more containers of eLiquid are at least one of refillable, disposable and replaceable.

8. The device of claim 6, wherein the eLiquids are heated.

9. The device of claim 8, wherein the water-based eLiquid is combined with at least one of a flavoring, nicotine, medication, wellness elements, aromatherapy elements and legal recreational elements in water soluble or controlled dispersal form.

10. The device of claim 8, wherein the at least the water component of the water-based eLiquid is distilled, purified, spring, tap, subjected to reverse osmosis, heated, cooled, or treated with vibrational frequencies including but not limited to sound. The device of claim 8, wherein the water-based eLiquid and the PG/VG based eLiquid may reside in separate containers or where the water-based eLiquid is mixed with PG/VG in calibrated proportion as regulated by a system controller, based upon at least one of default system settings and user selected settings, prior to heating.

12. The device of claim 11, wherein the water-based eLiquid container includes antibacterial or microbial protection elements.

13. The device of claim 1, wherein the hybrid shuttle device is a vapor device hybrid handset, a microvapor device or a monocle vapor device.

14. The device of claim 1, wherein the hybrid shuttle device includes a piezoelectric heating element to heat at least a water-based eLiquid, where the water is largely free of propylene glycol (PG) and vegetable glycerin (VG), and wherein the hybrid shuttle device includes either a shared or distinct heating element which heats PG/VG based eLiquid.

15. The device of claim 14, wherein a wick and pump system powered by a system battery feeds the water-based eLiquid into the heating element.

16. The device of claim 14, wherein an exit from the heating element includes at least one of multiple grated cavities, a pump and a sprinkler/perforated nozzle system.

17. The device of claim 16, including the perforated nozzle or sprinkler system.

18. The device of claim 16, including aromatherapy elements, including at least one of perfumes, flowers, spices; and mint.

19. The device of claim 1, wherein the hybrid shuttle device contains an on/off switch, a stealth or vapor trail switch, a battery, a microprocessor/controller, storage, software, memory and a contact point to transmit and verify user data.

20. The device of claim 19, wherein the microprocessor/controller is a kapton based printed microprocessor, a standard evapor device microprocessor, or a hybrid microprocessor containing elements of each.

21. The device of claim 1, wherein the hybrid shuttle device utilizes a heating element that is at least one of a piezoelectric heating element, a heated coil element, a standard eCig and modified vapor device heating element.

22. The device of claim 1, wherein a bottom end cap of the hybrid shuttle device comprises a contact point, the contact point designed to contact and communicate with a smart device, and wherein the hybrid shuttle device includes software for verification of user data and communication of systems data and information.

23. The device of claim 1, further comprising a mouthpiece, wherein the mouthpiece is either standard sized or wider than standard size at approximately ¾″ circumference.

24. The device of claim 23, including a seal disposed between one or more dispersing elements and the mouthpiece.

25. The device of claim 1, including a battery providing power to powered elements of the device via conductive wire, other conductive material or conductive liquid.

26. The device of claim 25, wherein the device utilizes said powered elements to operate device system functions for usage meters, gauges, lights, sounds, skin effects, data readings, communications, ecommerce or medical care.

27. A method comprising:
receiving, at a first device, a second device, wherein the first device comprises a first screen, wherein the second device comprises a second screen, wherein the first device comprises a vaping component, wherein the first device comprises a gaming component, and wherein at least a portion of the first screen overlaps at least a portion of the second screen; and
synchronizing display on the first screen and display on the second screen such that the first screen and the second screen appear to form a seamless third screen, wherein the at least the portion of the first screen displays the same content as the at least the portion of the second screen.

28. The method of claim 27, wherein the first device comprises an updateable library of games.

29. The method of claim 27, wherein the first device comprises at least one terabyte of flash data storage.

30. The method of claim 29, wherein the first device comprises at least twenty games.

31. The method of claim 27, wherein the first screen is wrappable.

32. The method of claim 27, wherein the first screen is flexible.

33. The method of claim 27, wherein a plurality of pixels associated with the at least the portion of the first screen are substantially the same as a corresponding plurality of pixels associated with the at least the portion of the second screen.

34. The method of claim 27, wherein the first device controls what is displayed on the first screen and the second screen.

35. The method of claim 27, wherein the second device controls what is displayed on the first screen and the second screen.

36. The method of claim 27, wherein the first device comprises a first audio output, and wherein the second device comprises a second audio output.

37. The method of claim 36, wherein the first device controls what is heard via the first audio output and the second audio output.

38. The method of claim 36, wherein the second device controls what is heard via the first audio output and the second audio output.

39. The method of claim 27, wherein the second device is a smart phone.

40. A method comprising:
connecting a first device with a second device, wherein the first device comprises a first screen, wherein the second device comprises a second screen, wherein the second device comprises a vaping component, wherein the second device comprises a gaming component, and wherein at least a portion of the first screen is overlapped by at least a portion of the second screen; and
synchronizing display on the first screen and display on the second screen such that the first screen and the second screen appear to form a seamless third screen, wherein the at least the portion of the first screen displays the same content as the at least the portion of the second screen.

41. The method of claim 40, wherein the second device comprises an updateable library of games.

42. The method of claim 40, wherein the second device comprises at least one terabyte of flash data storage.

43. The method of claim 42, wherein the second device comprises at least twenty games.

44. The method of claim 40, wherein the second screen is wrappable.

45. The method of claim 40, wherein the second screen is flexible.

46. The method of claim 40, wherein a plurality of pixels associated with the at least the portion of the first screen are substantially the same as a corresponding plurality of pixels associated with the at least the portion of the second screen.

47. The method of claim 40, wherein the first device controls what is displayed on the first screen and the second screen.

48. The method of claim 40, wherein the second device controls what is displayed on the first screen and the second screen.

49. The method of claim 40, wherein the first device comprises a first audio output, and wherein the second device comprises a second audio output.

50. The method of claim 49, wherein the first device controls what is heard via the first audio output and the second audio output.

51. The method of claim 49, wherein the second device controls what is heard via the first audio output and the second audio output.

52. The method of claim 40, wherein the first device is a smart phone.

53. A first device comprising:
a first screen;
a vaping component;
a gaming component;
a port configured to receive a second device, wherein the second device comprises a second screen, and wherein at least a portion of the first screen overlaps at least a portion of the second screen; and
a processor configured to synchronize display on the first screen and display on the second screen such that the first screen and the second screen appear to form a seamless third screen, wherein the at least the portion of the first screen displays the same content as the at least the portion of the second screen.

54. The first device of claim 53, wherein the first device comprises an updateable library of games.

55. The first device of claim 53, wherein the first device comprises at least one terabyte of flash data storage.

56. The first device of claim 55, wherein the first device comprises at least twenty games.

57. The first device of claim 53, wherein the first screen is wrappable.

58. The first device of claim 53, wherein the first screen is flexible.

59. The first device of claim 53, wherein a plurality of pixels associated with the at least the portion of the first screen are substantially the same as a corresponding plurality of pixels associated with the at least the portion of the second screen.

60. The first device of claim 53, wherein the first device controls what is displayed on the first screen and the second screen.

61. The first device of claim 53, wherein the second device controls what is displayed on the first screen and the second screen.

62. The first device of claim 53, wherein the first device comprises a first audio output, and wherein the second device comprises a second audio output.

63. The first device of claim 62, wherein the first device controls what is heard via the first audio output and the second audio output.

64. The first device of claim 62, wherein the second device controls what is heard via the first audio output and the second audio output.

65. The first device of claim 53, wherein the second device is a smart phone.

66. A first device comprising:
a first screen;
a connector configured to couple with a second device, wherein the second device comprises a second screen, wherein the second device comprises a vaping component, wherein the second device comprises a gaming component, and wherein at least a portion of the first screen is overlapped by at least a portion of the second screen; and
a processor configured to synchronize display on the first screen and display on the second screen such that the first screen and the second screen appear to form a seamless third screen, wherein the at least the portion of the first screen displays the same content as the at least the portion of the second screen.

67. The first device of claim 66, wherein the second device comprises an updateable library of games.

68. The first device of claim 66, wherein the second device comprises at least one terabyte of flash data storage.

69. The first device of claim 68, wherein the second device comprises at least twenty games.

70. The first device of claim 66, wherein the second screen is wrappable.

71. The first device of claim 66, wherein the second screen is flexible.

72. The first device of claim 66, wherein a plurality of pixels associated with the at least the portion of the first screen are substantially the same as a corresponding plurality of pixels associated with the at least the portion of the second screen.

73. The first device of claim 66, wherein the first device controls what is displayed on the first screen and the second screen.

74. The first device of claim 66, wherein the second device controls what is displayed on the first screen and the second screen.

75. The first device of claim 66, wherein the first device comprises a first audio output, and wherein the second device comprises a second audio output.

76. The first device of claim 75, wherein the first device controls what is heard via the first audio output and the second audio output.

77. The first device of claim 75, wherein the second device controls what is heard via the first audio output and the second audio output.

78. The first device of claim 66, wherein the first device is a smart phone.
